(19) United States
(12) Patent Application Publication
(10) Pub. No.: US 2025/0122125 A1
(43) Pub. Date: Apr. 17, 2025

(54) Method for Treating Gypsum and Making a Gypsum Board

(71) Applicant: Gold Bond Building Products, LLC, Charlotte, NC (US)

(72) Inventors: Xing Yang, Charlotte, NC (US); Ratnasabapathy Gurunathan Iyer, Charlotte, NC (US)

(21) Appl. No.: 18/912,685

(22) Filed: Oct. 11, 2024

Related U.S. Application Data
(60) Provisional application No. 63/590,033, filed on Oct. 13, 2023.

(51) Int. Cl. C04B 28/14; C04B 111/00

(52) U.S. Cl. CPC C04B 28/142; C04B 2111/0062

(57) ABSTRACT

In general, the present disclosure is directed to a method of making a gypsum board. The method comprises: applying a hydrophilic compound to a first gypsum composition to provide a hydrophilic compound modified gypsum composition; calcining the hydrophilic compound modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

### CROSS-REFERENCE TO RELATED APPLICATION

The present application claims filing benefit of U.S. Provisional Patent Application No. 63/590,033 having a filing date of Oct. 13, 2023, which is hereby incorporated by reference in its entirety.

### BACKGROUND OF THE DISCLOSURE

Gypsum boards are commonly employed in drywall construction of interior walls and ceilings and also have other applications. Generally, these gypsum boards are formed from a gypsum slurry including a mixture of calcined gypsum, water, and other conventional additives for various applications. For instance, certain additives may be provided to enhance the moisture-resistance properties of the gypsum board. However, in certain instances, such additives may result in a negative effect on certain characteristics and properties. For instance, such additives may affect the foam utilized in making the gypsum board. This could in turn also result in blisters/blows of the gypsum board, cosmetic issues with the gypsum board, increased surfactant usage, increased amount of waste, and/or other undesired properties or characteristics to the board itself and/or the overall process. These effects may especially be exhibited when utilizing reclaimed (or recycled) gypsum containing such moisture-resistance additives.

As a result, there is a need to provide an improved method of making a gypsum board.

### SUMMARY OF THE DISCLOSURE

In accordance with one embodiment of the present disclosure, a method of making a gypsum board is disclosed. The method comprises: applying a hydrophilic compound to a first gypsum composition to provide a hydrophilic compound modified gypsum composition; calcining the hydrophilic compound modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

In accordance with another embodiment of the present disclosure, a gypsum board is disclosed. In particular, the gypsum board is made by the aforementioned method comprising: applying a hydrophilic compound to a first gypsum composition to provide a hydrophilic compound modified gypsum composition; calcining the hydrophilic compound modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

In accordance with another embodiment of the present disclosure, a method of making a gypsum board is disclosed. The method comprises: applying a hydrophilic compound to a first gypsum composition to provide a hydrophilic compound modified gypsum composition, wherein the first gypsum composition comprises reclaimed gypsum and an organosilicon compound; calcining the hydrophilic compound modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

In accordance with another embodiment of the present disclosure, a gypsum board is disclosed. In particular, the gypsum board is made by the aforementioned method comprising: applying a hydrophilic compound to a first gypsum composition to provide a hydrophilic compound modified gypsum composition, wherein the first gypsum composition comprises reclaimed gypsum and an organosilicon compound; calcining the hydrophilic compound modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

Other features and aspects of the present disclosure are set forth in greater detail below.

### BRIEF DESCRIPTION OF THE DRAWINGS

The disclosure will now be described, by way of example, with reference to the accompanying drawings, in which:

FIGS. 1A-1D illustrate the samples of Example 1.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a method of making a gypsum board using a hydrophilic compound as defined herein. The present inventors have discovered that the manner in which such compound is provided can result in an improved gypsum board manufacturing process and/or provide a gypsum board with improved properties.

In particular, when providing the hydrophilic compound as defined herein in the manner as described, the cosmetic properties of the board may be improved. In this regard, the resulting gypsum board may exhibit fewer blisters or blows. In addition, the gypsum core of the resulting gypsum board may have better bond with the facing material, such as a paper facing material.

In addition, the method as disclosed herein may also allow for better foam efficiency thereby potentially allowing for less soap usage to obtain a certain weight board. For instance, utilizing a hydrophilic compound in the manner as described herein may allow for gypsum boards to maintain a desired void structure. In certain embodiments and without intending to be limited by theory, introduction of the hydrophilic compound in the manner as described herein may have benefits in obtaining a desired void structure compared to introduction of the hydrophilic compound in a mixer. In particular, the gypsum board may have desired void sizes and/or void distribution.

For instance, the percentage of core voids having a diameter of less than 300 microns may be 90% or less, such as 80% or less, such as 70% or less, such as 60% or less, such as 50% or less, such as 40% or less, such as 30% or less, such as 25% or less, such as 20% or less, such as 15% or less, such as 10% or less of the total core voids. In this regard, the percentage of core voids having a diameter of less than 300 microns may be 0.01% or more, such as 0.1% or more, such as 0.2% or more, such as 0.5% or more, such as 1% or more, such as 2% or more, such as 3% or more, such as 5% or more, such as 8% or more, such as 10% or more. In one embodiment, such core voids may reference any air voids due to voids generated from the use of a soap/foam.

Similarly, the percentage of core voids having a diameter of less than 150 microns may be 60% or less, such as 50% or less, such as 40% or less, such as 30% or less, such as 25% or less, such as 20% or less, such as 15% or less, such as 10% or less, such as 5% or less of the total core voids. In this regard, the percentage of core voids having a diameter of less than 150 microns may be 0.01% or more, such as 0.1% or more, such as 0.2% or more, such as 0.5% or more, such as 1% or more, such as 2% or more, such as 3% or more, such as 5% or more, such as 8% or more, such as 10% or more. In one embodiment, such core voids may reference any air voids due to voids generated from the use of a soap/foam.

Further, the percentage of core voids having a diameter of less than 100 microns may be 50% or less, such as 40% or less, such as 30% or less, such as 25% or less, such as 20% or less, such as 15% or less, such as 10% or less, such as 5% or less of the total core voids. In this regard, the percentage of core voids having a diameter of less than 100 microns may be 0.01% or more, such as 0.1% or more, such as 0.2% or more, such as 0.5% or more, such as 1% or more, such as 2% or more, such as 3% or more, such as 5% or more, such as 8% or more, such as 10% or more. In one embodiment, such core voids may reference any air voids due to voids generated from the use of a soap/foam.

In addition, the percentage of core voids having a diameter of less than 50 microns may be 30% or less, such as 25% or less, such as 20% or less, such as 15% or less, such as 10% or less, such as 5% or less of the total core voids. In this regard, the percentage of core voids having a diameter of less than 50 microns may be 0.01% or more, such as 0.1% or more, such as 0.2% or more, such as 0.5% or more, such as 1% or more, such as 2% or more, such as 3% or more, such as 5% or more, such as 8% or more. In one embodiment, such core voids may reference any air voids due to voids generated from the use of a soap/foam.

In addition, the average core void size may be 50 microns or more, such as 75 microns or more, such as 100 microns or more, such as 125 microns or more, such as 150 microns or more, such as 200 microns or more, such as 250 microns or more, such as 275 microns or more, such as 300 microns or more, such as 325 microns or more, such as 350 microns or more, such as 375 microns or more, such as 400 microns or more, such as 500 microns or more, such as 600 microns or more, such as 700 microns or more, such as 800 microns or more, such as 900 microns or more, such as 1,000 microns or more. The average core void size may be 1,500 microns or less, such as 1,300 microns or less, such as 1,100 microns or less, such as 1,000 microns or less, such as 900 microns or less, such as 800 microns or less, such as 700 microns or less, such as 600 microns or less, such as 550 microns or less, such as 500 microns or less, such as 450 microns or less, such as 400 microns or less, such as 375 microns or less, such as 350 microns or less, such as 325 microns or less, such as 300 microns or less, such as 275 microns or less, such as 250 microns or less, such as 225 microns or less, such as 200 microns or less, such as 175 micron or less, such as 150 microns or less, such as 125 microns or less, such as 100 microns or less. In one embodiment, such core voids may reference any air voids due to voids generated from the use of a soap/foam. Furthermore, while the aforementioned references an average core void size, it should be understood that in another embodiment, such size may also refer to a median core void size.

The void sizes may be determined using means in the art. For instance, a scanning electron microscope may be utilized wherein cross-sections are analyzed at a 50× magnification at random locations of a panel with one each close to the face of the panel, one in the center of the panel, and one close to the back of the panel. The voids are measured in an area of approximately 4 mm² and the average and median sizes are based on measuring all voids having a size of 30 microns or greater in diameter. During the review, edge circumferences are drawn on the voids and measured to calculate the void size and area.

Furthermore, the core voids may have an open geometry (i.e., open-cell), a closed geometry (i.e., closed-cell), or a mixture thereof. In one embodiment, the core voids may be closed-cell or have a closed geometry. In another embodiment, the core voids may be open-cell or have an open-geometry. In general, with an open geometry, the voids may be interconnected. This is contrary to closed-cell, which do not include interconnections. Accordingly, in certain embodiments, at least 0.01%, such as at least 1%, such as at least 5%, such as at least 10%, such as at least 20%, such as at least 30%, such as at least 40%, such as at least 50%, such as at least 60%, such as at least 70%, such as at least 80%, such as at least 90% of the voids may be open-celled voids or have an open geometry. In addition, in certain embodiments, 100% or less, such as 95% or less, such as 90% or less, such as 85% or less, such as 80% or less, such as 75% or less, such as 60% or less, such as 50% or less, such as 40% or less, such as 30% or less of the voids may be open-celled voids or have an open geometry.

In general, the method includes at least the following steps: applying a hydrophilic compound as defined herein to a first gypsum composition to provide a hydrophilic compound modified gypsum composition; calcining the hydrophilic compound modified gypsum composition to provide a calcined gypsum composition; preparing a gypsum slurry by combining water and the calcined gypsum composition; depositing the gypsum slurry on a first facing material; providing a second facing material on the gypsum slurry; and allowing the calcined gypsum to convert to calcium sulfate dihydrate.

As indicated above, the hydrophilic compound is applied to a first gypsum composition to provide a hydrophilic compound modified gypsum composition. In general, the term “hydrophilic” refers to any compound that attracts water molecules. Accordingly, without intending to be limited, the hydrophilic compound may be a compound that possesses strong intermolecular forces through hydrogen bonding or ionic bonding. Without intending to be limited, such compounds may assist in increasing surface energy. For instance, without intending to be limited, such compounds may improve the efficiency of using reclaim containing organosilicon compounds by increasing the surface energy of such compounds (e.g., a siloxane network present within the reclaim).

The form of the hydrophilic compound is not necessarily limited. For instance, the hydrophilic compound may be a solid or a liquid. In one embodiment, the hydrophilic compound may be a liquid. In another embodiment, the hydrophilic compound may be a solid. The hydrophilic compound may be presented as a solution or dispersion. For instance, it may be provided as a hydrophilic composition including the hydrophilic compound and a liquid. In one embodiment, the liquid may be water. In this regard, the hydrophilic compound may be provided as an aqueous solution in one embodiment. In another embodiment, the hydrophilic compound may be provided as an aqueous dispersion. In one embodiment, the hydrophilic compound may be miscible in water.

The hydrophilic compound may be a micromolecule or a macromolecule. In one embodiment, the hydrophilic compound may be a micromolecule. In another embodiment, the hydrophilic compound may be a macromolecule. The hydrophilic compound may be oligomeric in one embodiment. In another embodiment, the hydrophilic compound may be polymeric.

In this regard, the hydrophilic compound may have a certain molecular weight. For instance, the molecular weight may be 30 g/mol or more, such as 40 g/mol or more, such as 50 g/mol or more, such as 80 g/mol or more, such as 100 g/mol or more, such as 200 g/mol or more, such as 300 g/mol or more, such as 500 g/mol or more, such as 800 g/mol or more, such as 1000 g/mol or more, such as 1500 g/mol or more, such as 2000 g/mol or more, such as 2500 g/mol or more, such as 3000 g/mol or more, such as 4000 g/mol or more, such as 5000 g/mol or more, such as 6000 g/mol or more, such as 7000 g/mol or more, such as 8000 g/mol or more, such as 9000 g/mol or more, such as 10000 g/mol or more, such as 12000 g/mol or more, such as 14000 g/mol or more, such as 16000 g/mol or more, such as 18000 g/mol or more. The molecular weight may be 30000 g/mol or less, such as 28000 g/mol or less, such as 26000 g/mol or less, such as 24000 g/mol or less, such as 22000 g/mol or less, such as 20000 g/mol or less, such as 18000 g/mol or less, such as 16000 g/mol or less, such as 14000 g/mol or less, such as 12000 g/mol or less, such as 10000 g/mol or less, such as 8000 g/mol or less, such as 6000 g/mol or less, such as 5000 g/mol or less, such as 4000 g/mol or less, such as 3000 g/mol or less, such as 2600 g/mol or less, such as 2200 g/mol or less, such as 2000 g/mol or less, such as 1800 g/mol or less, such as 1600 g/mol or less, such as 1400 g/mol or less, such as 1200 g/mol or less, such as 1000 g/mol or less, such as 900 g/mol or less, such as 800 g/mol or less, such as 700 g/mol or less, such as 600 g/mol or less, such as 500 g/mol or less. The aforementioned may refer to a weight average molecular weight in one embodiment. In another embodiment, the aforementioned may refer to a number average molecular weight. Typically, such weight average molecular weight and/or number average molecular weight may be utilized to reference oligomeric or polymeric materials. The molecular weight may be generally known or determined using means known in the art, such as gel permeation chromatography.

In one embodiment, the hydrophilic compound may have a functional group that provides the compound with hydrophilic properties. For instance, the functional group may be a hydroxyl group, an amine group, an amide group, a carbonyl group, a carboxyl group, a sulfhydryl group, or a combination thereof. In one embodiment, the functional group may be a hydroxyl group, an amine group, an amide group, a carboxyl group, a sulfhydryl group, or a combination thereof. In another embodiment, the functional group may be a hydroxyl group, an amine group, an amide group, a carboxyl group, or a combination thereof. In a further embodiment, the functional group may be a hydroxyl group, an amine group, an amide group, or a combination thereof.

In one embodiment, the functional group may be a hydroxyl group. In this regard, such compound may have one hydroxyl group in one embodiment or more than one hydroxyl group in another embodiment. Such compounds may include alcohols, glycols, etc. In another embodiment, the functional group may be an amine group. The amine may be a primary amine, a secondary amine, or a tertiary amine. In an embodiment, the functional group may be an amide group. In a further embodiment, the functional group may be a carbonyl group. Such compounds may give rise to aldehydes, ketones, etc. In another embodiment, the functional group may be a carboxyl group. Such compounds may give rise to carboxylic acids. In an even further embodiment, the functional group may be a sulfhydryl group. Such compounds may give rise to thiols, etc.

In general, it should be understood that the hydrophilic compound may include any combination of the aforementioned functional groups.

In one embodiment, such functional group may be present at one or more terminal ends of the compound (e.g., if the compound is oligomeric or polymeric). In another embodiment, such functional group may be present as a graft on the compound (e.g., if the compound is oligomeric or polymeric). In an even further embodiment, such functional group may be present at one or more terminal ends and as a graft on the compound (e.g., if the compound is oligomeric or polymeric).

The hydrophilic compound may include, but is not limited to, a polyol, a vinyl alcohol, a glycol, urea, or a mixture thereof. For instance, the polyol may include, but is not limited to, glycerol, sorbitol, xylitol, maltitol, and/or a polyol polymer. For instance, the polyol polymer may include, but is not limited to, polydextrose. The vinyl alcohol may include, but is not limited to, polyvinyl alcohol. The glycol may include, but is not limited to, ethylene glycol, propylene glycol, butylene glycol, hexylene glycol, polyethylene glycol, polypropylene glycol, etc. or a mixture thereof. In one embodiment, the hydrophilic compound may include polyethylene glycol, polypropylene glycol, or a mixture thereof. In another embodiment, the hydrophilic compound may include glycerol. In a further embodiment, the hydrophilic compound may include polyvinyl alcohol. In an even further embodiment, the hydrophilic compound may include urea.

In general, it should be understood that the hydrophilic compound may include any combination of the aforementioned compounds. Furthermore, the hydrophilic compound may be utilized in combination with other enhancing additives before calcination, including those aforementioned compounds.

Without intending to be limited, the benefits of utilizing a hydrophilic compound in the manner as described herein may be realized due to interactions with the hydrophilic compound. For instance, without intending to be limited, the hydrophilic compound may increase the surface energy of potential water repellants or hydrophobic compounds such as by passivating the potential water repellants or hydrophobic compounds. Without intending to be limited, this may be done because the hydrophilic compound may form a surface coating on the potential water repellants or hydrophobic compounds. In this regard and as an example only, the hydrophilic compound may bond to certain atoms, such as silicon atoms, due to favorable bonds. For instance, when containing an organosilicon compound as described herein, this may result in the formation of energetically favorable bonds and thus reduce the water-repellant effects of certain groups, such as alkyl (R) groups, of the organosilicon compound. With the precalcination addition of the hydrophilic compound as disclosed herein, it may contribute to an increased breakage of Si—R bonds and reduce or eliminate the negative effects of reclaim use and silicone on foam formation. Particularly, without intending to be limiting, the hydrophilic compound may assist with breaking a crosslink of a siloxane network by breaking Si—R bonds, such as Si—CH₃ bonds, to form Si—OH bonds.

The method of application of the hydrophilic compound may be any as generally known in the art. For instance, the method may include misting, spraying, mixing/blending, grinding, etc. Accordingly, the manner in which the hydrophilic compound is applied is not necessarily limited by the present disclosure. In addition, the hydrophilic compound may be applied as a solid, as a dispersion/solution, or a combination thereof. Furthermore, once applied, the modified gypsum composition may be utilized immediately for calcining (or combining with a virgin gypsum to provide a second gypsum composition as disclosed herein). Alternatively, it may be stored for a certain period of time. For instance, it may be allowed to dry to remove free moisture or free water prior to calcining.

The hydrophilic compound may be applied to the first gypsum composition in an amount of 0.001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the first gypsum composition. The hydrophilic compound may be applied to the first gypsum composition in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the first gypsum composition. In one embodiment, the aforementioned weight percentages may be based on the weight of the gypsum present in the first gypsum composition.

In general, the first gypsum composition comprises gypsum. For instance, the gypsum may be uncalcined. In this regard, the gypsum may comprise calcium sulfate dihydrate. The gypsum may be a virgin gypsum, a reclaimed gypsum, or a mixture thereof. In one embodiment, the gypsum may be reclaimed gypsum. In another embodiment, the gypsum may be virgin gypsum. In a further embodiment, the gypsum may be a mixture of a virgin gypsum and a reclaimed gypsum. The source of the gypsum, whether for the virgin gypsum or the reclaimed gypsum, may be a natural source or a synthetic source and is thus not necessarily limited by the present disclosure.

As generally understood, virgin gypsum is gypsum that has not been processed to make a product or article whereas reclaimed gypsum is gypsum that has been made into a product or article and is being reclaimed or recycled. In this regard, such gypsum directly from a natural source or a synthetic source may be referred to as a virgin gypsum. Meanwhile, reclaimed gypsum may be virgin gypsum that has been used and processed (e.g., for making a gypsum board) and is being recycled in the gypsum board manufacturing process to make a new gypsum board. Reclaimed gypsum may also include a combination of virgin gypsum and reclaimed gypsum or entirely reclaimed gypsum that has already once been used and processed (e.g., for making a gypsum board) and is being recycled in the gypsum board manufacturing process to make a new gypsum board.

Thus, the gypsum to which the hydrophilic compound is being applied may be virgin gypsum, reclaimed gypsum, or a combination thereof. In one embodiment, the gypsum may be virgin gypsum. In another embodiment, the gypsum may be reclaimed gypsum. In a further embodiment, the gypsum may be a mixture of virgin gypsum and reclaimed gypsum. When present as a mixture, the amount of reclaimed gypsum is not necessarily limited.

In general, when the first gypsum composition comprises reclaimed gypsum, certain benefits may be realized. For instance, such use of reclaimed gypsum may allow for a reduction in the amount of waste. In this regard, rather than sending used gypsum product/boards to waste or a landfill, such gypsum may be reclaimed or recycled. In this regard, the method as disclosed herein may also be environmentally friendly.

In this regard, when the first gypsum composition comprises reclaimed gypsum, it may also include other components. For instance, the first gypsum composition may also comprise a reclaimed facing material. For instance, the facing material may be as one described herein. In particular, the reclaimed facing material may be a reclaimed paper facing material in one embodiment. In another embodiment, the reclaimed facing material may be a reclaimed fibrous mat facing material. The first gypsum composition may also comprise an organosilicon compound, in particular a reclaimed organosilicon compound. For instance, such organosilicon compound may have been utilized in forming the gypsum product or article that is being reclaimed. In a particular embodiment, the first gypsum composition may comprise a mixture of the reclaimed facing material and the organosilicon compound along with the gypsum as defined herein.

The organosilicon compound may comprise a silane, a polymethylhydrogensiloxane, a siloxane resin, a polysilane, an organosilanol, a disiloxane, an oligosiloxane, a polysiloxane, an organosiliconate, or a mixture thereof. In this regard, the organosilicon compound may be a micromolecule or a macromolecule. For instance, the organosilicon compound may be a network, such as a crosslinked network in one embodiment.

Suitable organosilicon compounds encompass, for example, silanes such as tetraorganosilanes SiR₄ and organoorganoxysilanes SiRₙ (OR′)₄₋ₙ with n=1 to 3, polymethylhydrogensiloxanes, siloxane resins, polysilanes preferably of the general formula R₃Si(SiR₂)ₙSiR₃ with n=0 to 500, organosilanols such as SiRₙ (OH)₄₋ₙ, disiloxanes, oligosiloxanes, polysiloxanes for example composed of units of the general formula R_{c}H_{d}Si(OR′)ₑ(OH)_{f}O_{(4-c-d-e-f)/2} with c=0 to 3, d=0 to 1, e=0 to 3, f=0 to 3, and with the sum c+d+e+f per unit being no more than 3.5, with R in each case being identical or different and denoting branched or unbranched alkyl radicals having 1 to 22 C atoms, cycloalkyl radicals having 3 to 10 C atoms, alkylene radicals having 2 to 4 C atoms, and also aryl, aralkyl, and alkylaryl radicals having 6 to 18 C atoms, and R′ denoting identical or different alkyl radicals and alkoxyalkylene radicals having in each case 1 to 4 C atoms, preferably methyl and ethyl, it also being possible for the radicals R and R′ to be substituted by halogens such as chlorine, by ether, thioether, ester, amide, nitrile, hydroxyl, amine, carboxyl, sulfonic acid, carboxylic anhydride, and carbonyl groups, and in the case of the polysilanes it also being possible for R to have the definition OR′. In one embodiment, the organosilicon compound may be a polysiloxane comprising a polymethylhydrogensiloxane.

Further examples of the organosilicon compounds are organosiliconates, more particularly alkyl siliconates, such as monomeric or oligomeric alkylsilanetriols. Organosiliconates are obtainable, for example, by reaction of one or more organoalkoxysilanes with one or more polyhydroxy compounds or, preferably, with one or more alkali metal lyes. Organoalkoxysilanes preferred for the preparation of organosiliconates are methyltrimethoxysilane, methyltriethoxysilane, ethyltrialkoxysilane, propyltri-methoxysilanes, butyltrimethoxysilanes, pentyltri-alkoxysilanes, hexyltrimethoxysilanes, heptyltrimethoxysilanes, octyltrimethoxysilanes. Examples of alkali metal lyes are sodium hydroxide or potassium hydroxide, more particularly in the form of their aqueous solutions. Examples of suitable polyhydroxy compounds are alkanediols, such as ethylene glycol, diethylene glycol, triethylene glycol, polyethylene glycol, 1,2-propanediol or 1,3-propanediol, alkanetriols, such as glycerol, alkanetetrols, such as pentaerythritol, hydroxycarboxylic acids, such as lactic acid, citric acid, or tartaric acid, saccharides, such as sugars, more particularly glucose, sucrose, or fructose, or starch. The reaction products may comprise basic or acidic constituents, examples being catalysts which may be added in order to promote the elimination of alkoxy groups.

Particularly preferred organosilicon compounds are methyltrimethoxysilane, methyltriethoxysilane, ethyltrimethoxysilane, ethyltriethoxysilane, propyltrimethoxysilanes, propyltriethoxysilanes, n-butyltrimethoxysilane, isobutyltrimethoxysilane, pentyltrimethoxysilanes, hexyltrimethoxysilanes, cyclohexyltrimethoxysilane, methyltripropoxysilane, methyltri-(ethoxyethoxy)silane, vinyltri(methoxyethoxy)silane, (meth)acryloyloxypropyltrimethoxysilane, (meth)acryloyloxypro-pyltriethoxysilane, γ-chloropropyltriethoxysilane, β-nitrilo-ethyltriethoxysilane, γ-mercaPtopropyltrimethoxysilane, γ-mer-captopropyltriethoxysilane, phenyltriethoxysilane, heptyltrimethoxysilane, heptyltriethoxysilanes, isooctyltri-ethoxysilane, n-octyltriethoxysilane, hexadecyltriethoxysilanes, dipropyldiethoxysilanes, methylphenyldiethoxysilane, diphenyldimethoxysilane, methylvinyltri(ethoxyethoxy)silane, tetramethyldiethoxy-disilane, trimethyltrimethoxydisilane, trimethyltriethoxydisilane, dimethyltetramethoxydisilane, dimethyltetraethoxydisilane, methylhydrogenpolysiloxanes endblocked with trimethylsiloxy groups, copolymers endblocked with trimethylsiloxy groups and composed of dimethylsiloxane and methylhydrogensiloxane units, dimethylpolysiloxanes, and also dimethylpolysiloxanes with Si—OH groups in the terminal units.

Accordingly, the organosilicon compounds may include any of the aforementioned as well as polymers, oligomers, and/or networks formed from such compounds. For instance, such compounds may be utilized to form an oligomer, a polymer, and/or a corresponding network, all of which are encompassed by organosilicon compounds.

In addition to the above, the first gypsum composition may include other components. For instance, these other components may include those present with the reclaimed gypsum in the gypsum product/article. In this regard, these other components may include those conventionally utilized in the art. In particular, these may include those conventional additives as indicated below. Furthermore, they may be included in the first gypsum composition in the amount as disclosed below with respect to conventional additives and/or in the amount as disclosed below with respect to the organosilicon compound.

Furthermore, in the first gypsum composition, the reclaimed gypsum may be present in an amount of 0.1 wt. % or more, such as 0.2 wt. % or more, such as 0.5 wt. % or more, such as 0.8 wt. % or more, such as 1 wt. % or more, such as 2 wt. % or more, such as 3 wt. % or more, such as 5 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 60 wt. % or more, such as 70 wt. % or more, such as 80 wt. % or more, such as 90 wt. % or more, such as 95 wt. % or more based on the total weight of the gypsum in the composition. The reclaimed gypsum may be present in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 3 wt. % or less, such as 1 wt. % or less based on the total weight of the gypsum in the composition. In one embodiment, such aforementioned weight percentages may also refer to the weight percentages of the reclaimed gypsum based on the weight of the first gypsum composition. In another embodiment, such aforementioned weight percentages may also refer to the weight percentages based on gypsum, in particular calcined gypsum, in the gypsum slurry as defined herein. In one embodiment, such aforementioned weight percentages may also refer to the weight percentages based on gypsum in the gypsum board as defined herein.

In addition, in the first gypsum composition, the organosilicon compound may be present in an amount of 0.0001 wt. % or more, such as 0.001 wt. % or more, such as 0.005 wt. % or more, such as 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more based on the weight of the first gypsum composition. The organosilicon compound may be present in an amount of 10 wt. % or less, such as 8 wt. % or less, such as 6 wt. % or less, such as 5 wt. % or less, such as 4 wt. % or less, such as 3 wt. % or less, such as 2.5 wt. % or less, such as 2 wt. % or less, such as 1.5 wt. % or less, such as 1.3 wt. % or less, such as 1 wt. % or less, such as 0.8 wt. % or less, such as 0.5 wt. % or less, such as 0.3 wt. % or less based on the weight of the first gypsum composition. In one embodiment, such aforementioned weight percentages may also refer to the weight percentages of the organosilicon compound based on the weight of gypsum in the first gypsum composition. In another embodiment, such aforementioned weight percentages may also refer to the weight percentages based on reclaimed gypsum in the first gypsum composition.

In one embodiment, the gypsum board may be made from a combination of virgin gypsum and reclaimed gypsum. In this regard, in one embodiment, the application of the hydrophilic compound may be to a first gypsum composition comprising virgin gypsum and reclaimed gypsum to provide a hydrophilic compound modified gypsum composition. In another embodiment, the application of the hydrophilic compound may be to a first gypsum composition comprising reclaimed gypsum to provide a hydrophilic compound modified gypsum composition. Thereafter in such embodiment, the hydrophilic compound modified gypsum composition may be combined with virgin gypsum to provide a second gypsum composition. Then, the second gypsum composition may be calcined to provide a calcined gypsum composition.

In this regard, in the second gypsum composition, the reclaimed gypsum may be present in an amount of 0.1 wt. % or more, such as 0.2 wt. % or more, such as 0.5 wt. % or more, such as 0.8 wt. % or more, such as 1 wt. % or more, such as 2 wt. % or more, such as 3 wt. % or more, such as 5 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 60 wt. % or more, such as 70 wt. % or more, such as 80 wt. % or more, such as 90 wt. % or more, such as 95 wt. % or more based on the total weight of the gypsum in the composition. The reclaimed gypsum may be present in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less, such as 8 wt. % or less, such as 5 wt. % or less, such as 3 wt. % or less, such as 1 wt. % or less based on the total weight of the gypsum in the composition. In one embodiment, such aforementioned weight percentages may also refer to the weight percentages of the reclaimed gypsum based on the weight of the second gypsum composition. In another embodiment, such aforementioned weight percentages may also refer to the weight percentages based on gypsum, in particular calcined gypsum, in the gypsum slurry as defined herein. In one embodiment, such aforementioned weight percentages may also refer to the weight percentages based on gypsum in the gypsum board as defined herein.

Generally, calcined gypsum may be referred to as calcium sulfate hemihydrate. The manner in which calcination may occur is not limited by the present disclosure and can be conducted using any means generally known in the art. The calcination (or dehydration) process in the manufacture of stucco (i.e., calcium sulfate hemihydrate) is performed by heating the gypsum which yields calcium sulfate hemihydrate and water vapor. In particular, the calcination removes bound water from the gypsum (i.e., calcium sulfate dihydrate) to yield stucco (i.e., calcium sulfate hemihydrate). Generally, this may be conducted using any “calciner” known in the art and is not limited by the present disclosure. For instance, any suitable furnace or reactor may be used. As examples, a kettle calciner, a flash calciner, a rotary kiln, or a combination thereof may be used to carry out the calcination. As one example, a flash calcination process is disclosed in U.S. Pat. No. 11,446,620, which is incorporated herein by reference in its entirety. Without intending to be limited regarding the conditions, calcination may be conducted at substantially atmospheric pressure. However, it should be understood that it may be conducted at other pressures, such as higher pressures. Furthermore, calcination may be conducted in either a continuous process or a batch process.

The calcination may also be conducted using a single staged apparatus or a multi-staged apparatus. Furthermore, in one embodiment, the calcination may be conducted in a continuous process. In another embodiment, the calcination may be conducted in a batch process.

The calcination may be conducted at any temperature suitable to convert gypsum to stucco. For instance, calcining may be carried out at a temperature of about 100° C. or more, such as about 120° C. or more, such as about 140° C. or more, such as about 160° C. or more, such as about 180° C. or more, such as about 200° C. or more, such as about 220° C. or more, such as about 240° C. or more, such as about 300° C. or more, such as about 400° C. or more, such as about 500° C. or more, such as about 600° C. or more, such as about 800° C. or more, such as about 1,000° C. or more. The calcining may be carried out at a temperature of about 1,300° C. or less, such as about 1,100° C. or less, such as about 1,000° C. or less, such as about 800° C. or less, such as about 700° C. or less, such as about 600° C. or less, such as about 500° C. or less, such as about 400° C. or less, such as about 300° C. or less, such as about 280° C. or less, such as about 260° C. or less, such as about 240° C. or less, such as about 220° C. or less, such as about 200° C. or less, such as about 180° C. or less, such as about 160° C. or less, such as about 140° C. or less.

The calcining may be conducted for any suitable period of time as required to reduce the content of the bound water from the gypsum to on-average one-half of mole of water per mole of calcium sulfate (i.e., to calcium sulfate hemihydrate). However, generally, the calcination may not be conducted for such period of time to promote formation, in particular considerable formation, of insoluble anhydrous gypsum. In this regard, the calcining may be conducted such that the average residence time of the gypsum in the calciner is about 0.0001 hours or more, such as 0.001 hours or more, such as 0.005 hours or more, such as 0.01 hours or more, such as 0.05 hours or more, such as 0.1 hours or more, such as 0.2 hours or more, such as 0.5 hours or more, such as 0.75 hours or more, such as 1 hour or more, such as 1.5 hours or more, such as 2 hours or more. The average residence time may be 5 hours or less, such as 4 hours or less, such as 3 hours or less, such as 2.5 hours or less, such as 2 hours or less, such as 1.8 hours or less, such as 1.6 hours or less, such as 1.4 hours or less, such as 1.2 hours or less, such as 1 hour or less, such as 0.8 hours or less, such as 0.6 hours or less, such as 0.5 hours or less, such as 0.4 hours or less, such as 0.3 hours or less, such as 0.2 hours or less, such as 0.1 hours or less, such as 0.05 hours or less, such as 0.01 hours or less.

Furthermore, even though the hydrophilic compound modified gypsum composition or second gypsum composition have been calcined to form a calcined gypsum composition, in some embodiments, the calcined gypsum composition may contain the hydrophilic compound. In this regard, the hydrophilic compound may be present in an amount of 10 wt. % or less, such as 8 wt. % or less, such as 6 wt. % or less, such as 5 wt. % or less, such as 4 wt. % or less, such as 3 wt. % or less, such as 2 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.3 wt. % or less, such as 0.2 wt. % or less, such as 0.1 wt. % or less, such as 0.05 wt. % or less based on the weight of the calcined gypsum composition. The hydrophilic compound may be present in an amount of 0.0001 wt. % or more, such as 0.001 wt. % or more, such as 0.005 wt. % or more, such as 0.01 wt. % or more, such as 0.02 wt. % or more, such as 0.05 wt. % or more, such as 0.1 wt. % or more, such as 0.2 wt. % or more, such as 0.3 wt. % or more, such as 0.5 wt. % or more, such as 1 wt. % or more based on the weight of the calcined gypsum composition.

After calcination, a gypsum slurry is prepared. The gypsum slurry can be prepared by combining water and the calcined gypsum composition. In addition, optional additives may also be combined to form the gypsum slurry.

For instance, in addition to the calcined gypsum composition which comprises calcined gypsum (i.e., stucco or calcium sulfate hemihydrate), the gypsum slurry may also be formed by providing or including calcium sulfate dihydrate and/or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. %, based on the weight of the calcium sulfate hemihydrate and the calcium sulfate dihydrate. The calcium sulfate dihydrate may be present in an amount of 20 wt. % or less, such as 15 wt. % or less, such as 10 wt. % or less, such as 8 wt. % or less, such as 5 wt. % or less, such as 4 wt. % or less, such as 3 wt. % or less, such as 2 wt. % or less, such as 1 wt. % or less, such as 0.8 wt. % or less, such as 0.6 wt. % or less, such as 0.4 wt. % or less, such as 0.2 wt. % or less, such as 0.1 wt. % or less to 0 wt. % or more, such as 0.1 wt. % or more, such as 0.2 wt. % or more, such as 0.3 wt. % or more, such as 0.5 wt. % or more, such as 0.8 wt. % or more, such as 1 wt. % or more. Furthermore, the calcined gypsum may be α-hemihydrate, β-hemihydrate, or a mixture thereof.

In addition to the calcined gypsum composition, the gypsum slurry may also contain other hydraulic materials. These hydraulic materials may include land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

The hydrophilic compound may be present in the gypsum slurry in an amount of 0.001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more based on the weight of the calcined gypsum composition. The hydrophilic compound may be present in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the calcined gypsum composition. In one embodiment, the aforementioned weight percentages may be based on the weight of the calcined gypsum present in the calcined gypsum composition.

The hydrophilic compound may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more. The hydrophilic compound may be present in an amount of 150 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

As indicated above, the gypsum slurry may also include water. Water may be employed for fluidity and also for rehydration of the gypsum to allow for setting. The amount of water utilized is not necessarily limited by the present disclosure.

In this regard, the weight ratio of the water to the stucco may be 0.1 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the calcined gypsum composition and water, the gypsum slurry may also include any other conventional additives as known in the art. Thus, the method may also include providing any of the additives to form the gypsum slurry. In this regard, such additives are not necessarily be limited by the present disclosure. For instance, the additives may include dispersants, foam or foaming agents including aqueous foam (e.g. sulfates), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes, secondary phosphates (e.g., condensed phosphates or orthophosphates including trimetaphosphates, polyphosphates, and/or cyclophosphates, etc.), polymers (natural polymers and/or synthetic polymers), mixtures thereof, etc. In general, it should be understood that the types and amounts of such additives are not necessarily limited by the present disclosure.

In general, each additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the stucco. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco. In one embodiment, the aforementioned weight percentage may be based on the weight of the gypsum slurry. In another embodiment, the aforementioned weight percentage may be based on the solids content of the gypsum slurry.

As indicated above, the additives may include at least one dispersant. The dispersant is not necessarily limited and may include any that can be utilized within the gypsum slurry and the hydrophilic compound disclosed herein. The dispersant may include carboxylates (e.g., carboxylate ether, polycarboxylate ether, polycarboxylate ester), sulfates, sulfonates (e.g., naphthalene sulfonate, a lignosulfonate), mixtures thereof, etc. For instance, in one embodiment, the dispersant may include a sulfate.

As indicated above, the additives may include at least one accelerator. The accelerator is not necessarily limited and may include any that can be utilized within the gypsum slurry and the hydrophilic compound disclosed herein. The accelerator may include ground or unground gypsum such as from a ball mill accelerator, land plaster, sulfate salts, etc., as well as a mixture thereof. In one embodiment, the accelerator may include at least a ball mill accelerator (BMA).

As indicated above, the additives may include at least one foaming agent. The foaming agent is not necessarily limited and may include any that can be utilized within the gypsum slurry and the hydrophilic compound disclosed herein. In this regard, such foaming agent may be present in the gypsum slurry as well as the resulting gypsum core and gypsum board.

The foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate.

The alkyl sulfate may have a general formula as follows:

H(CH₂)ₙOSO₃⁻M⁺

wherein n is from 6 to 16 and M is a monovalent cation. In this regard, the alkyl sulfate includes alkyl chains. The alkyl may be linear, branched, or include a combination thereof. The average chain length of the alkyls may be 6 carbons or more, such as 7 carbons or more, such as 8 carbons or more, such as 9 carbons or more, such as 10 carbons or more, such as 11 carbons or more. The average chain length of the alkyls may be 15 carbons or less, such as 14 carbons or less, such as 13 carbons or less, such as 12 carbons or less, such as 11 carbons or less, such as 10 carbons or less, such as 9 carbons or less. In general, such average chain length is determined based on the length of the alkyl chains, not considering the length of any component of any alkyl ether sulfate that may be present. In addition, such average chain length is a weighted average chain length based on the amount of each specific alkyl present.

The monovalent cation may be sodium or ammonium. In one embodiment, the monovalent cation may be ammonium. In another embodiment, the monovalent cation may be sodium.

The alkyl ether sulfate may have a general formula as follows:

CH₃(CH₂)ₓCH₂—(OCH₂CH₂)_{y}—OSO₃⁻M⁺

wherein x is from 4 to 13, y is from 0.05 to 5, and M is a monovalent cation.

The alkyl portion of the alkyl ether sulfate may be 6 carbons or more, such as 7 carbons or more, such as 8 carbons or more, such as 9 carbons or more, such as 10 carbons or more, such as 11 carbons or more. Accordingly, x may be 4 or more, such as 5 or more, such as 6 or more, such as 7 or more, such as 8 or more, such as 9 or more, such as 10 or more. The alkyl portion of the alkyl ether sulfate may be 15 carbons or less, such as 14 carbons or less, such as 13 carbons or less, such as 12 carbons or less, such as 11 carbons or less, such as 10 carbons or less, such as 9 carbons or less. Accordingly, x may be 13 or less, such as 11 or less, such as 10 or less, such as 9 or less, such as 8 or less.

The ethoxylated content (y) of the alkyl ether sulfate may be 0.05 or more, such as 0.1 or more, such as 0.2 or more, such as 0.3 or more, such as 0.5 or more, such as 1 or more, such as 1.2 or more, such as 1.5 or more, such as 1.8 or more, such as 2 or more, such as 2.2 or more, such as 2.5 or more, such as 3 or more. The ethoxylated content of the alkyl ether sulfate may be 5 or less, such as 4.8 or less, such as 4.5 or less, such as 4.3 or less, such as 4 or less, such as 3.7 or less, such as 3.5 or less, such as 3.2 or less, such as 3 or less, such as 2.8 or less, such as 2.5 or less, such as 2.3 or less, such as 2 or less, such as 1.7 or less, such as 1.5 or less, such as 1.3 or less, such as 1 or less, such as 0.9 or less, such as 0.7 or less.

The monovalent cation may be sodium or ammonium. In one embodiment, the monovalent cation may be ammonium. In another embodiment, the monovalent cation may be sodium.

When a mixture of an alkyl sulfate and an alkyl ether sulfate is present, the alkyl ether sulfate may be present in an amount of from more than 0 wt. % to less than 100 wt. %. For instance, in the mixture, the alkyl ether sulfate may be present in an amount of more than 0 wt. %, such as 0.01 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more. In the mixture, the alkyl ether sulfate may be present in an amount of less than 100 wt. %, such as 95 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less. Such weight percentage may be based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 0.001 or more, such as 0.005 or more, such as 0.01 or more, such as 0.05 or more, such as 0.1 or more, such as 0.2 or more, such as 0.3 or more, such as 0.5 or more, such as 1 or more, such as 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less, such as 3 or less, such as 2 or less, such as 1 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum board and the resulting properties.

In one aspect, the foam may be provided in an amount of 1 lb/MSF or more, such as 5 lbs/MSF or more, such as 10 lbs/MSF or more, such as 15 lbs/MSF or more, such as 20 lbs/MSF or more, such as 25 lbs/MSF or more, such as 30 lbs/MSF or more, such as 50 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less, such as 80 lbs/MSF or less, such as 60 lbs/MSF or less, such as 50 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco and water. In this regard, such starch may be present in the gypsum slurry as well as the resulting gypsum core and gypsum board.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example. In one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum board, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more, such as 120° C. or more, such as 140° C. or more, such as 160° C. or more, such as 180° C. or more. The gelling temperature may be 300° C. or less, such as 260° C. or less, such as 220° C. or less, such as 200° C. or less, such as 180° C. or less, such as 160° C. or less, such as 140° C. or less, such as 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively higher gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present disclosure.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

The manner in which the components are combined to form the gypsum slurry is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the method may include a step of combining any of the other aforementioned components mentioned above with respect to the gypsum slurry.

Once the gypsum slurry is prepared, the method may comprise a step of depositing the gypsum slurry onto a first facing material. The first facing material may be conveyed on a conveyor system (i.e., a continuous system for continuous manufacture of gypsum board). Next, a second facing material is provided on top of the gypsum slurry such that the gypsum slurry is sandwiched between the facing materials in order to form the gypsum board.

The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material.

After deposition, the calcium sulfate hemihydrate reacts with the water to convert the calcium sulfate hemihydrate into a matrix of calcium sulfate dihydrate. Such reaction may allow for the gypsum to set and become firm thereby allowing for the boards to be cut at the desired length. In this regard, the method may comprise a step of reacting calcium sulfate hemihydrate with water to form calcium sulfate dihydrate or allowing the calcium sulfate hemihydrate to convert to calcium sulfate dihydrate. In this regard, the method may allow for the slurry to set to form a gypsum board. In addition, during this process, the method may allow for dewatering of the gypsum slurry, in particular dewatering any free water instead of combined water of the gypsum slurry. Such dewatering may occur prior to the removal of any free moisture or water in a heating device after a cutting step. Thereafter, the method may also comprise a step of cutting a continuous gypsum sheet into a gypsum board. Then, after the cutting step, the method may comprise a step of supplying the gypsum board to a heating or drying device. For instance, such a heating or drying device may be a kiln and may allow for removal of any free water. The temperature and time required for drying in such heating device are not necessarily limited by the present disclosure.

In addition, the present disclosure is also directed to a gypsum board. The gypsum board includes a gypsum core sandwiched between two facing materials. The gypsum board may comprise calcium sulfate dihydrate and a hydrophilic compound as defined herein. The manner in which the gypsum board is made is as provided herein utilizing the aforementioned application, calcination, preparation, and deposition steps.

In one embodiment, the gypsum core may include a first gypsum core layer and a second gypsum core layer. The first gypsum core layer may be between the first facing material (i.e., front of the gypsum board) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (i.e., back of the gypsum board). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as the hydrophilic compound as defined herein. Further, the first gypsum core layer, the second gypsum core layer, and/or the third gypsum core layer may contain an additive in an amount as previously indicated herein.

Regardless of the above, the hydrophilic compound may be present in any combination of gypsum core layers. However, in one embodiment, it should be understood that one or two of the aforementioned gypsum core layers may not include the hydrophilic compound. In one aspect, one or more gypsum core layers may comprise the same hydrophilic compound. Further, in one aspect, the one or more gypsum core layers may comprise different hydrophilic compounds. The different hydrophilic compounds of the one or more gypsum core layers may be chosen such that it is advantageous to have a particular hydrophilic compound in one gypsum core layer and a different hydrophilic compound in another, different gypsum core layer.

The gypsum board disclosed herein may have many applications. For instance, the gypsum board may be used as a standalone board in construction for the preparation of walls, ceilings, floors, etc. As used in the present disclosure, the term “gypsum board,” generally refers to any board, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum board forms part of a building structure, such as a wall or ceiling.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum board is not necessarily limited and may be from about 0.25 inches to about 1 inch. For instance, the thickness may be at least ¼ inches, such as at least 5/16 inches, such as at least ⅜ inches, such as at least 4/10 inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. With regard to the thickness, the term “about” may be defined as within 10%, such as within 5%, such as within 4%, such as within 3%, such as within 2%, such as within 1%.

In this regard, the gypsum board may have a density of about 5 pcf or more, such as about 10 pcf or more, such as about 15 pcf or more, such as about 20 pcf or more. The board may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less.

In addition, the board weight of the gypsum board is not necessarily limited. For instance, the gypsum board may have a board weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more, such as about 2000 lbs/MSF or more, such as about 2500 lbs/MSF or more, such as about 3000 lbs/MSF or more. The board weight may be about 5000 lbs/MSF or less, such as about 4500 lbs/MSF or less, such as about 4000 lbs/MSF or less, such as about 3500 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such board weight may be a dry board weight such as after the board leaves the heating or drying device (e.g., kiln).

In addition to the above, the gypsum board may have certain desired mechanical properties or strength. The gypsum board may have a certain nail pull resistance, which generally is a measure of the force required to pull a gypsum board off a wall by forcing a fastening nail through the board. The values obtained from the nail pull test generally indicate the maximum stress achieved while the fastener head penetrates through the board surface and core. In certain embodiments, the nail pull resistance may be improved due to the use of the hydrophilic compound as defined herein. In this regard, the gypsum board exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as determined according to ASTM C1396-17. The nail pull resistance may be about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as determined according to ASTM C1396-17. Such nail pull resistance may be based upon the thickness of the gypsum board. For instance, when conducting a test, such nail pull resistance values may vary depending on the thickness of the gypsum board. As an example, the nail pull resistance values above may be for a ⅝ inch board. However, it should be understood that instead of a ⅝ inch board, such nail pull resistance values may be for any other thickness gypsum board as mentioned herein.

The gypsum board may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the thickness of the gypsum board. For instance, when conducting a test, such compressive strength values may vary depending on the thickness of the gypsum board. As an example, the compressive strength values above may be for a ⅝ inch board. However, it should be understood that instead of a ⅝ inch board, such compressive strength values may be for any other thickness gypsum board as mentioned herein.

In addition, the gypsum board may have a core hardness of at least about 8 lb_{f}, such as at least about 10 pounds, such as at least about 11 lb_{f}, such as at least about 12 lb_{f}, such as at least about 15 lb_{f}, such as at least about 18 lb_{f}, such as at least about 20 lb_{f} as determined according to ASTM C1396-17. The gypsum board may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb or less, such as about 15 lb_{f} or less as determined according to ASTM C1396-17. In addition, the gypsum board may have an end hardness according to the aforementioned values. Further, the gypsum board may have an edge hardness according to the aforementioned values. Such core hardness may be based upon the thickness of the gypsum board. For instance, when conducting a test, such core hardness values may vary depending on the thickness of the gypsum board. As an example, the core hardness values above may be for a ⅝ inch board. However, it should be understood that instead of a ⅝ inch board, such core hardness values may be for any other thickness gypsum board as mentioned herein.

In addition, it may also be desired to have an effective bond between the facing material and the gypsum core. Typically, a humidified bond analysis is performed for 2 hours in a humidity chamber at 90° F. and 90% humidity. In this test, after exposure, the facing material is removed to determine how much remains on the gypsum board. The percent coverage can be determined using various optical analytical techniques. In this regard, the facing material may cover less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum board. Alternatively, such percentage may be for a back of the gypsum board. Further, such percentages may apply to the face and the back of the gypsum board. In addition, such values may be for an average of at least 3 gypsum boards, such as at least 5 gypsum boards.

### EXAMPLES

### Example 1

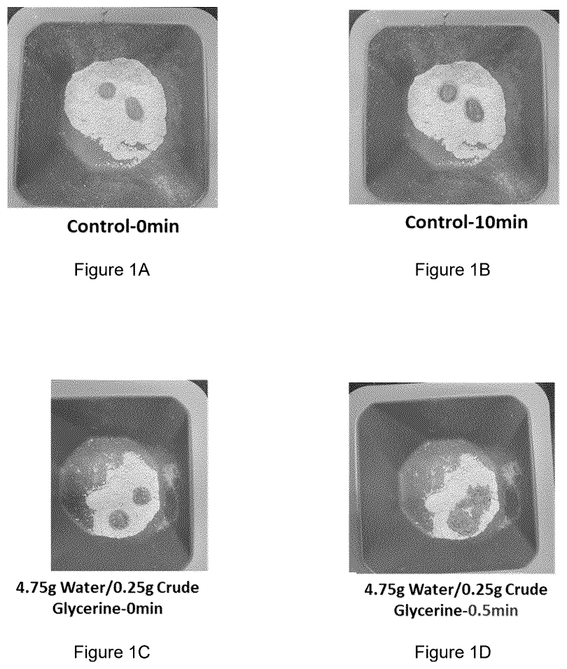

Reclaimed gypsum (15 g) was pulverized and then subjected to treatment with water (control) or with a 5 wt. % solution of glycerol. The treated reclaimed gypsum was calcined. Then, water was dropped on top of 0.5 g of the treated, calcined sample and the time required for absorption of water into the sample was measured. The results for the control are illustrated in FIGS. 1A-1B at 0 minutes and after 10 minutes. The results for the glycerol treated sample are illustrated in FIGS. 1C-1D at 0 minutes and 0.5 minutes. As illustrated by the figures, the sample treated with glycerol demonstrated quicker absorption of water than the water-treated reclaimed gypsum.

### Example 2

Gypsum compositions were made by adding calcined reclaim to stucco at 10% by weight. The control gypsum board sample contained untreated or water-treated calcined reclaim wherein water was sprayed onto the reclaim at 10% by weight of the reclaim. The inventive gypsum board samples contained reclaim treated with glycerol or sodium monofluorophosphate prior to calcination. In particular, a 10 wt. % solution or a 30 wt. % solution (as specified in the table below) in water was created and then applied to the reclaim wherein the amount of the glycerol or sodium monofluorophosphate was either 7.5 lbs or 22.5 lbs per ton of reclaim (as also specified in the table below). The gypsum compositions were calcined wherein the calcined gypsum composition was formed into a slurry and combined with water and foam (130 g). Thereafter, the slurry was provided between paper facing materials and allowed to set. The gypsum board samples were analyzed to determine the effect of the application of the hydrophilic compound before calcination.

| | | Avg. | | Avg. |
|---|---|---|---|---|
| | Wet wt. | Wet wt. | Dry wt. | Dry Wt. |
| Gypsum Board Sample | (lb/msf) | (lbs/msf) | (lb/msf) | (lbs/msf) |
| Reclaim | 2505 | 2458 | 1571 | 1537 |
| | 2410 | | 1503 | |
| Reclaim/SMFP 7.5 lb/ton | 2320 | 2300 | 1448 | 1434 |
| (10% solution) | 2280 | | 1420 | |
| Reclaim/Glycerol 7.5 lb/ton | 2365 | 2368 | 1470 | 1475 |
| (10% solution) | 2370 | | 1480 | |
| Reclaim/Glycerol 22.5 lb/ton | 2330 | 2290 | 1445 | 1415 |
| (30% solution) | 2250 | | 1385 | |

As indicated in the table above, the control board showed substantial defoaming. Without intending to be limited, defoaming may be indicated by an increase in weight when using the same amount of foam. In the table above, a decrease in weight was observed for the inventive gypsum board samples compared to the control board sample thereby suggesting the inventive gypsum board samples had less defoaming than the control board sample. Accordingly, treatment with glycerol reduced/minimized the negative effect on foam when mixing reclaim with pristine stucco.

Meanwhile, when adding 22.5 lb/ton (glycerol/reclaim) glycerol directly into gauging water for preparing the gypsum slurry, no substantial improvements were realized compared to the control as shown in the following table.

| | Wet Wt. | Dry Wt. |
|---|---|---|
| Gypsum Board Sample | (lb/msf) | (lb/msf) |
| Reclaim | 2320 | 1442 |
| Reclaim/Glycerol 22.5 lb/ton added in gauging water | 2310 | 1445 |

These and other modifications and variations of the present disclosure may be practiced by those of ordinary skill in the art without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

1. A method for making a gypsum board, the method comprising:
applying a hydrophilic compound to a first gypsum composition to provide a hydrophilic compound modified gypsum composition;
calcining the hydrophilic compound modified gypsum composition to provide a calcined gypsum composition;
preparing a gypsum slurry by combining water and the calcined gypsum composition;
depositing the gypsum slurry on a first facing material;
providing a second facing material on the gypsum slurry; and
allowing the calcined gypsum to convert to calcium sulfate dihydrate.

2. The method of claim 1, wherein the hydrophilic compound comprises a functional group including a hydroxyl group, an amine group, an amide group, a carbonyl group, a carboxyl group, a sulfhydryl group, or a combination thereof.

3. The method of claim 1, wherein the hydrophilic compound comprises a functional group including a hydroxyl group, an amine group, or an amide group.

4. The method of claim 1, wherein the hydrophilic compound comprises a polyol, a vinyl alcohol, a glycol, urea, or a mixture thereof.

5. The method of claim 1, wherein the hydrophilic compound comprises a polyol.

6. The method of claim 1, wherein the hydrophilic compound comprises glycerol.

7. The method of claim 1, wherein the hydrophilic compound comprises a glycol.

8. The method of claim 1, wherein the hydrophilic compound is present in the slurry in an amount of from 0.001 wt. % to 5 wt. % based on the weight of the stucco.

9. The method of claim 1, wherein the gypsum slurry further comprises a foaming agent comprising an alkyl sulfate, an alkyl ether sulfate, or a mixture thereof.

10. The method of claim 1, wherein the first gypsum composition comprises virgin gypsum.

11. The method of claim 1, wherein the first gypsum composition comprises reclaimed gypsum.

12. The method of claim 1, wherein the first gypsum composition comprises reclaimed gypsum and virgin gypsum.

13. The method of claim 1, wherein the first gypsum composition comprises an organosilicon compound.

14. The method of claim 1, wherein the first gypsum composition comprises a polysiloxane.

15. The method of claim 1, wherein the first gypsum composition comprises reclaimed gypsum and an organosilicon compound.

16. The method of claim 15, wherein the organosilicon compound comprises a polysiloxane.

17. The method of claim 11, further comprising combining the modified gypsum composition with virgin gypsum to provide a second gypsum composition, calcining the second gypsum composition to provide the calcined gypsum composition.

18. The method of claim 15, further comprising combining the modified gypsum composition with virgin gypsum to provide a second gypsum composition, calcining the second gypsum composition to provide the calcined gypsum composition.

19. A gypsum board made from the method of claim 1.

20. A method for making a gypsum board, the method comprising:
applying a hydrophilic compound to a first gypsum composition to provide a hydrophilic compound modified gypsum composition,
wherein the first gypsum composition comprises reclaimed gypsum and an organosilicon compound;
calcining the hydrophilic compound modified gypsum composition to provide a calcined gypsum composition;
preparing a gypsum slurry by combining water and the calcined gypsum composition;
depositing the gypsum slurry on a first facing material;
providing a second facing material on the gypsum slurry; and
allowing the calcined gypsum to convert to calcium sulfate dihydrate.

21. The method of claim 20, wherein the first gypsum composition further comprises virgin gypsum.

22. The method of claim 20, further comprising combining the modified gypsum composition with virgin gypsum to provide a second gypsum composition, calcining the second gypsum composition to provide the calcined gypsum composition.

23. A gypsum board made from the method of claim 20.
